(19) United States
(12) Patent Application Publication
(10) Pub. No.: US 2005/0144597 A1
(43) Pub. Date: Jun. 30, 2005

(54) Transformation function of a TMN system

(76) Inventor: Christian Wolf, Berlin (DE)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 10/992,285

(22) Filed: Nov. 18, 2004

(30) Foreign Application Priority Data
Nov. 18, 2003 (EP) 03026531.8

(51) Int. Cl. G06F 9/45

(52) U.S. Cl. 717/136; 717/114

(57) ABSTRACT

The Transformation Function TF of a TMN system, which is used at the TMN system for connection of components with different communication mechanisms and especially for linking of network elements NE; which do not feature any standardized Network Element Function NEF, to execute a program implemented in a predicative programming language. Advantageously changes to the Network Element Function NEF can be added into the TMN systems without recompilation of the Transformation Function TF.

### CROSS REFERENCE TO RELATED APPLICATIONS

This application claims priority to the European application No. 03026531.8, filed Nov. 18, 2003 and which is incorporated by reference herein in its entirety.

### FIELD OF INVENTION

The invention relates to a transformation function of a TNM system.

### BACKGROUND OF INVENTION

A reference architecture of a Telecommunications Management Network (TMN) for monitoring and controlling a network for telecommunications applications is described in International Standard M.3010 (02/2000) of the ITU-T, which starts from the assumption that the network controlled by the TMN comprises different types of network element which are usually controlled using various communication mechanisms (i.e. protocols, messages, management information—also called object models).

This TMN includes the following functionalities:
Operations Systems Function (OSF), which implements the “actual” management of the telecommunications network.
Workstation Function (WSF) which is used for presentation of the control processes and of the network status for a human user of the TMN.
Network Element Function (NEF) which represents an interface for control of the telecommunications functions of the network elements. The interface defines the specific communications mechanism of the relevant network element which may possibly not be standardized. The totality of all management information of the NE is referred to as the Management Information Base (MIB) of the NE.
Transformation Function (TF) which is used for connec-tion of components with different communication mechanisms and especially for linkage to the TMN of network elements which do not feature a standardized NEF. It is also referred to in Standard M.3010 (05/96) as the Mediation Function or as the Q-Adaption function.

Physically the NEF is usually located in a network element (NE) and the OSF in an Operations System (OS). A Data Communication Network (DCN) can be provided between NE and OS for transfer of information. The transfer follows the principles of the transport service as described in the four lower layers of the ISO/OSI reference model in international standard X.200. Should a TF be required, it is integrated either into an NE or an OS or arranged as an autonomous device between NE and OS. The latter is also referred to as a Mediation Device (MD) or as an Adaptation Device (AD).

The individual TMN functions are usually implemented in contemporary TMN systems by function-specific programs These programs are described with the aid of programming languages. They are executed by hardware (e.g. processor, I/o module) which is provided in the device. This execution is supported by standard software (e.g. multitasking or multithreading operating system, database system, windows system).

The Transformation Function between different communication mechanisms and especially of different object models is usually effected with the aid of transformation programs. These are described with imperative programming languages which are converted for their execution into machine language by a compiler.

A programming language is a language for formulating computing specifications which can be executed by a computer. Depending on the degree to which the hardware has to be taken into account during programming, programming languages are classified into machine language (direct programming of the hardware), lower, machine-oriented Assembler languages (programming of the hardware with symbolic names) and higher, problem-oriented programming languages (are independent of the hardware and oriented to the problem cases to be processed). Each programming language is based on a specific concept or scheme of thought. Based on these concepts, the higher-level programming languages are subdivided into different categories such as imperative (e.g. PASCAL, C, COBOL), object-oriented (e.g. C++) or predicative programming languages (e.g. PROLOG).

With imperative programming languages a program consists of a sequence of commands to the computer. A given problem is resolved by the programmer assembling a sequence of instructions which are executed to obtain the solution.

With predicative programming languages programming is undertaken as proofs in a system of facts and conclusions. A given problem is resolved by the programmer specifying his own knowledge of a problem as a set of facts (=valid predicates) and rules (i.e. how one obtains new facts from existing facts) and the computer attempts with the aid of this knowledge to autonomously find a solution to the problem, e.g. determines independently, for queries made, whether they are to be answered as correct or incorrect. An example of a predicative programming language is PROLOG (=PROgramming in LOGic”).

The problem of relationships by marriage will be considered as an example for understanding a predicative programming language. The basic knowledge is the relationships “married” and “ischild”. Basic knowledge is represented in PROLOG as set of facts. Facts are always in the form “name (W₁, W₂, . . . Wₙ)”, where “name” is any name starting with a lower case letter and the Wₓ are any values. Facts are the relationships by marriage in the example
“married(man,wife)”
“ischild(child,mother)”

In this way a PROLOG system can be informed of the following facts (each individual fact is terminated by a period):
ischild(heinz,emma).
ischild(emma,elfriede).
ischild(hugo,elfriede).
married(anton,emma).
married(wilhelm,elfriede).
married(hugo,rosa).

After notifying these facts to the PROLOG system one can now enter queries and the PROLOG system outputs the solution which it finds (queries are identified by a question mark and output from the system by an asterisk):
?ischild(emma,elfriede).
*yes
?married(anton,rosa).
*no

One can also use variables for specific values in the queries. In this case the PROLOG system outputs all values for the variables for which it finds a solution. If for example you wish to know to whom “hugo” is married and which children “elfriede” has, you can make the following queries (variables always begin with an upper case letter):
?married(hugo,Wife).
*Wife=rosa
?ischild(Child,elfriede).
*Child=emma
*Child=hugo

It is also possible to combine a number of queries into one. In this case the PROLOG system only outputs those values for the variables which are fulfilled by all queries simultaneously (in logical terms one can also combine a number of queries by and). If you wish to find out who the father of “heinz” is you must ask who his mother is and to whom she is married (a number of queries are separated by commas):
?ischild(heinz,Mother),
married(Father,Mother).
*Mother=emma, Father=anton

If a variable occurs in a number of subqueries, this means that with a solution the values must also always be the same at all points. If one now often wants to know who the father of a child is it is very longwinded to always make the two subqueries above. For this reason one is able in PROLOG to write down levels as well as the basic knowledge in the form of facts. To query the father one can notify the PROLOG system of a rule “isfather” (rules are identified by a horizontal dash):
   |isfather(Father,Child):—
ischild(Child,Mother),
married (Father,Mother).

This rule states: “Father” is the father of “Child”, if (character:—) “Child” is the child of “Mother” and “Mother” is married to “Father” (the problem of step-fathers is not considered here). After the PROLOG system has received this rule it is possible to find out who “hugo's” father is or who “wilhelm's” children are through the following queries:
?isfather(Father,hugo).
*Father=wilhelm
?isfather(wilhelm,Child).
*Child=emma
*Child=hugo

Accordingly one can define rules for sisters (children are sisters if they have the same mother) or grandfathers (father of the father):
   |sister (Child1;Child2):—
ischild(Child1,Mother),
ischild(Child2,Mother).
grandfather (Grandpa,Grandchild):—
isfather(Grandpa,Father),
isfather(Father,Grandchild).

Facts and rules are the essential basic elements of PROLOG. To enable even complicated data to be processed with simple identifiers there is the option in PROLOG of providing structures of several items of data with one identifier. One can for example combine both parent parts into one unit designated “parents“:
“parents(wilhelm,elfriede)”,
“parents(anton,emma)”.

In all PROLOG systems rules are defined for calculation with numbers so that the language can also be used for arithmetic applications. However there has not previously been any uniform definition of the PROLOG language so the facts and rules can be entered differently depending on the PROLOG system.

The PROLOG system finds the solution to a given query by a backtracking method, i.e. all possibilities are tried out until such time as a solution is found or no further alternatives exist.

Because of their lack of machine orientation, higher-level programming languages cannot be executed directly in the hardware but must be converted beforehand using compilers into lower-level programming languages or executed with the aid of intermediate interpreters, by which the computing specifications of the higher-level programming language are converted into machine language during the execution of the program. Programs which are written in a higher-level imperative programming language are usually converted with the aid of compilers into a machine language which is then executed by the hardware. Interpreters or incremental compilers are predominantly used to execute programs which are written in a predicative programming language.

A compiler reads in the source code, analyzes it and outputs the compiled object code. When the source code is changed recompilation of the entire source code as well as a new start of the object code is necessary to render the changes effective.

An interpreter is a program which immediately executes a program of another programming language after the necessary syntactical checks. By contrast with a compiler the source code does not first have to be converted into another programming language but the interpreter analyzes each instruction and declaration of the source program in turn and executes these directly. Interpreters are used above all for programming languages with an orientation to dialog operation, such as APL, BASIC, LISP or PROLOG for example.

An incremental compiler has the source program and the object program in main memory at the same time. The programmer can modify his source program in dialog mode and the incremental compiler simultaneously modifies the object program so that the two programs have the same meaning (semantics). Small changes in the source program here mostly also lead to only small changes in the object program.

After what has been said previously it is clear that the conversion of this architecture into concrete solutions and especially implementing the Transformation Function represents a complex technical problem definition.

### SUMMARY OF INVENTION

The object of the invention is to understand the previous prior art and to enrich it by specifying at least one new disclosure.

It is a hard fact that Transformation Functions for TMN systems—as described at the start of this document—are implemented with the aid of imperative programming languages. In the view of the invention, one of the reasons for this is that the immanent logic of the Transformation Function:
IF
   Receive (Information x in the Format y of the object model z
THEN
   Transform (Format y≧y′) and
   Send (Information x in the Format y′ of the object model z′)
      is synonymous with the concept of the imperative languages. In addition imperatively written programs are converted with a compiler into a machine language before their execution, which brings with it the additional benefit that the Mediation Devices implemented in this way are especially efficient as regards memory requirements and runtime behavior.

An implementation with the aid of another programming language and especially a predicative programming language has not been considered before now. In the view of the invention, one of the reasons for this is that predicative programming languages, as a result of their basic idea of knowledge processing are firmly linked to artificial intelligence systems and expert systems or—since it is relatively simple to write a parser (syntactical analysis) for context-sensitive grammars in them—with systems for processing idiomatic records and for other types of problem area—especially in the area of classical IF-THEN situations—are viewed as not suitable, especially if these are coupled with high demands on system performance, as is the case with the Transformation Function.

The invention described in the patent claims departs from these basic beliefs by proposing, contrary to the general teaching, to implement the Transformation Function with the aid of a predicative programming language.

For example the management information of an MIB of the NE could be modeled as facts of a predicatively written program and accesses to the management information be implemented using predicatively formulated requests which are responded to in each case on the basis of the existing facts. As a response the system then supplies that management information for which all facts and rules of the system are true.

The invention has a large number of advantages:
For the incorporation of a new network element into a TMN system in most cases the development of a network-element specific TF for object model compilation between the proprietary MIB of the NE and the standardized object model of TMN system is required. Each TF must be tested after development, with each error correction demanding a tedious full compilation of the entire source code. The result of this is comparatively long test cycles which, as a result of the plurality of different TFs, impose a heavy load overall on the operation of a TMN system. This disadvantage is significantly reduced when predicative programming languages are used, since these languages are interpreted. The advantage of interpreters lies in the fact that the individual instructions or declarations can be modified in the source program and the program can be executed directly with these changes. Mostly one can also query and modify values of variables during program execution. This makes it significantly easier to test programs since the long test cycles are considerably reduced by elimination of the tedious full compilation of the entire source code.
These test cycles basically arise anew for each change in an MIB of an NE since the imperative programming languages, as a result of the tedious full compilation of the entire source code, are very inflexible in relation to changes in the MIB. This thus multiplies the time benefit which is obtained by the flexible handling of a predicative programming language.
Especially advantageous is an application of the invention in TMN systems with many different network elements, each with comparatively small MIBs. In these systems the advantages associated with the more flexible predicative programming languages accumulate especially heavily, whereas restrictions on system performance which are produced by the interpretation of the predicative program as a result of the small MIBs are kept within manageable limits.
A TF for new network elements can be described particularly elegantly in a predicative programming language, allowing time and money benefits to be obtained from reduced program generation times.
Changes in the MIB of the NE can be undertaken retroactively without any great effort by modifying the predicative program accordingly. This also applies to extensive and complex changes to the MIB since the Interpreters of predicative programs can process a large bandwidth of different facts and rules. In particular new management information and changes to the number of parameters of existing management information can be represented in a predicative program.

Further advantageous embodiments of the invention are produced by the subordinate and related claims.

One embodiment arises because of the idea that the system performance of a predicative program can be significantly improved, if the management information from the MIB of a NE is not stored as facts in the data storage of the predicative system but is administered with an imperatively programmed data storage system. With a hybrid overall systems of this type comprising imperative and predicative program elements a system performance is achieved which approaches a pure imperatively programmed TF. An especially good benefit of this embodiment lies in the fact that the system performance in relation to memory requirement and runtime behavior is so greatly improved that the requirements imposed on pure imperatively programmed TFs are not violated even with large MIBs.

This embodiment is based on the knowledge that interpreters demand a longer computing time for execution of programs, because for example on assignment of the address the variables used must be searched for with the aid of the identifiers, whereas when an interpreter is used the address is calculated once during the compilation. This is not however the main cause of the ever greater drop in system performance of a purely predicatively programmed TF as the size of an MIB increases. This is much rather attributable to the database of the predicative system. This will be explained in more detail using a PROLOG system as an example: The management information contained in the MIB of an NE must, In order to enable the PROLOG system to respond to queries relating to this MIB, be stored as facts retrieved by the NE and stored in the database of the PROLOG system. The insertion of information as PROLOG facts is usually implemented at run time of a PROLOG interpreter by what is known as an ASSERT clause. The relevant parts of MIB of the NEs are completely transferred into the Prolog database in this way and are then available from further processing. The ASSERT clause is a very powerful but also a slow operation which can only be used in connection with interpreters. The storage of the MIB in the PROLOG database is very memory-intensive when the ASSERT clause is used, access to it is very slow. The invention recognizes that this is the main cause of the fall in system performance of a purely predicatively programmed TF mentioned above.

In accordance with a further embodiment of the invention the scope of the predicative programming language is expanded by a special build-In predicate which is provided as an additional predicate in the interpreter of the predicative programming language. The processing of this predicate by the interpreter includes a method programmed in an imperative programming language, such as C++, which allows high-performance access to the MIB without violating the semantics of Prolog. With the introduction of the new built-In predicate it is very easily possible to search through the Prolog database for that management information which must be retrieved by the NE to enable the protocol conversion or object model conversion to be executed. In addition the form of the Prolog rules for object model conversion is simplified. This benefit is especially elegant if the management information is structured hierarchically (as in an SNMP MIB for example) and the imperative method is matched to this.

There is further provision for storing the MIB in the TF in a data store which is programmed in an imperative programming language such as. C++ for example. This brings with it the advantage that the management information of the MIB is no longer held as Prolog facts. The execution of the ASSERT operation can thus be omitted and memory requirement for the MIB of the NE reduced to the level of conventionally programmed TFs.

The invention is explained below on the basis of further exemplary embodiments which are also shown in the Figures.

### BRIEF DESCRIPTION OF THE DRAWINGS

FIG. 1 a typical implementation of the invention in a exemplary TMN system, comprising the TMN functions WSF, OSF, TF and NEF which are arranged in physical devices WS, OS, MD/AD and NE

FIG. 2 a typical embedding of two items of Management information from the MIB of a product cityLight from manufacturer XXXX in the Global Naming Tree

### DETAILED DESCRIPTION OF INVENTION

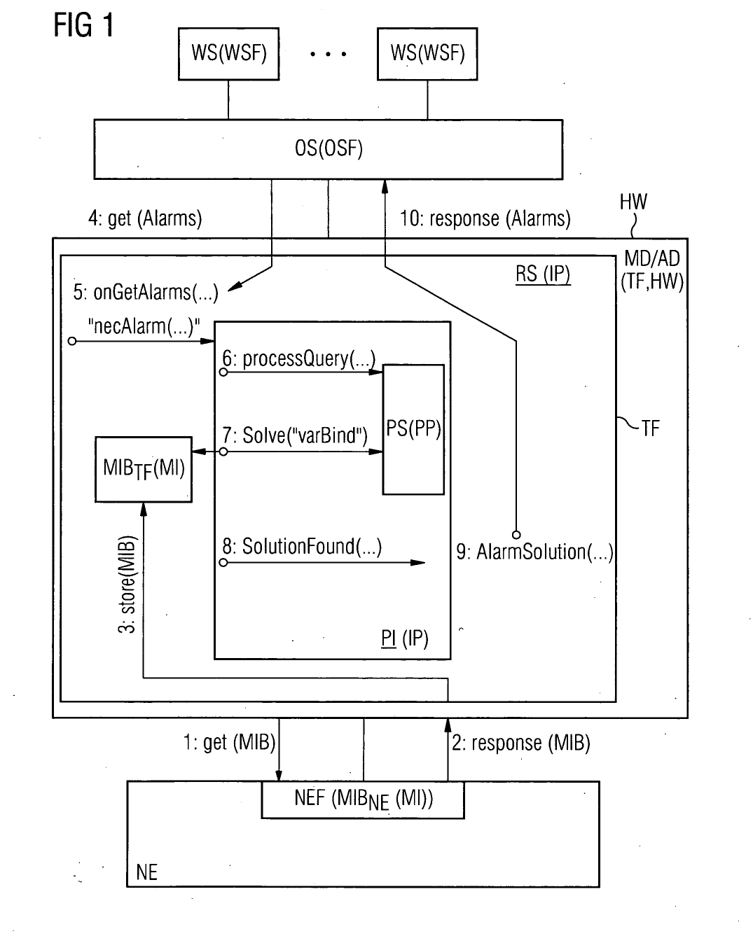

FIG. 1 shows a typical TMN system of the type described at the start. It compri,ses the function blocks Operations Systems Function OSF which is arranged in a device Operations System OS, Workstation Function WSF which are arranged in devices Workstation WS and Transformation Function TF which is arranged in a separate device MD/AD which can be embodied as a Mediation Device MD or as an Adaption Device. The device further includes hardware HW for execution of programs embodied as Runtime Systems RS, Prolog Interpreter PI and as Prolog Script PS. The programs RS and PI are written in an imperative programming language IP such as e.g. C++, the program PS in a predicative programming language PP such as PROLOG. Furthermore a typical flowchart is integrated into FIG. 1 which is listed below.

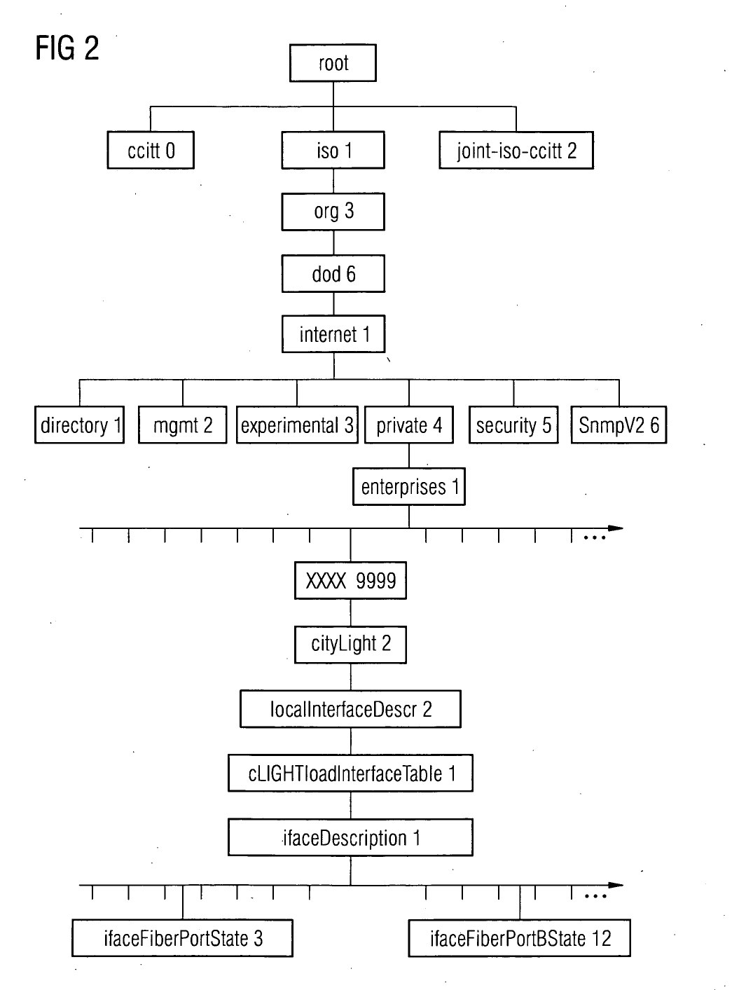

FIG. 2 describes a typical embedding of two items of Management information ifaceFiberPortState and ifaceFiberPortBState from the SNMP (Simple Network Management Protocol) MIB of a product cityLight of a manufacturer XXXX into the Global Naming Tree of the ISO/CCITT. This tree was defined by the International Organization for Standardization (ISO) and by the International Telegraph and Telephone Consultative Committee (CCITT)—today's International Telephone Union for Telecommunication (ITU-T)—with the aim of allocating a worldwide unique object identifier for each item of management information. Each node of the tree is identified by a label comprising a short text and a number. The upper part {root) ! {iso 1} ! {org 3} ! {dod 6} ! {internet 1) ! {private 4} ! {enterprises 1} of the tree is internationally standardized, the lower part is company-specific {XXXX 9999} ! {cityLigth 2} ! {localInterfaceDescr 2} ! {cLIGHTleadInterfaceTable 1} ! {ifaceDescription 1} ! {ifaceFiberPortState 3} or ! {ifaceFiberPortBState 12}. The Object Identifier of an item of management information is the sequence of numbers which identify the path of the root to the information. For better readability the numbers of the sequence are usually shown separated by a period. The management information ifaceFiberPortState is thus identified by the object identifier 1.3.6.1.4.1.9999.2.2.1.1.3 and the management information ifaceFiberPortBState by the object Identifier 1.3.6.1.4.1.9999.2.2.1.1.12.

It should be stressed that the embodiments of the invention shown, despite their very detailed presentation, are merely by way of examples and should not be seen as imposing any restrictions. It is clear to the person skilled in the art that the invention works for all conceivable network configurations, especially other interworking scenarios. In particular the SNMP protocol can be replaced by other protocols having the same effect and the predicative programming language PROLOG by other programming languages having the same effect.

An exemplary embodiment of the invention is explained below, in which the function OSF accesses the management information ifaceFiberPortState of the NE. For differentiation the management information ifaceFiberPortBState of the NE is shown in parallel. The MIB of the NE is designed in accordance with the rules of the SNMP (Simple Network Management protocol) which is incompatible with the communication mechanisms of the function OSF. The transformation thus required for access is brought about by the intermediate function TF with the collaboration of a PROLOG program (also called a script).

The basic requirement for accesses to an MIB is a description of the management information contained within it. The description below is a typical extract from a machine-readable SNMP specification of the MIB of the network element NE of company XXXX, which discloses information such as how access is possible to the management information ifaceFiberPortState and ifaceFiberPortBState in the network element NE:

-- ----------------------------------------------------------------------
-- Typical extract of MIB of company XXXX
-- ----------------------------------------------------------------------
DEFINITIONS ::= BEGIN
IMPORTS

| | private, Counter, TimeTicks, ObjectName, IpAddress, | |
|---|---|---|
| | OBJECT-TYPE | |
| | FROM RFC1155-SMI | |
| | DisplayString, PhysAddress | |
| | FROM RFC1213-MIB | |
| | TRAP-TYPE | |
| | FROM RFC-1215; | |
| -- | IMPORTS in particular: | |
| -- | iso | OBJECT IDENTIFIER ::= { root 1 } |
| -- | org | OBJECT IDENTIFIER ::= { iso 4 } |
| -- | dod | OBJECT IDENTIFIER ::= { org 6 } |
| -- | internet | OBJECT IDENTIFIER ::= { dod 1 } |
| -- | private | OBJECT IDENTIFIER ::= { internet 4 } |
| -- | NE specific definitions: | |

| | |
|---|---|
| enterprises | OBJECT IDENTIFIER ::= { private 1 } |
| XXXX | OBJECT IDENTIFIER ::= { enterprises |
| | 9999 } |
| cityLight | OBJECT IDENTIFIER ::= { XXXX 2 } |
| cityLightSystem | OBJECT IDENTIFIER ::= { cityLight 1 } |
| localInterfaceDescr | OBJECT IDENTIFIER ::= { cityLight 2 } |
| remoteInterfaceDescr | OBJECT IDENTIFIER :: = { |
| | cityLight 3 } |
| trapEnable | OBJECT IDENTIFIER ::= { cityLight 4 } |
| security | OBJECT IDENTIFIER ::= { cityLight 5 } |
| trapLog | OBJECT IDENTIFIER ::= { cityLight 6 } |

```
-- ===============================================
-- cityLight Local Port Descriptions variables
-- ===============================================
cLIGHTLocalInterfaceTable OBJECT-TYPE
    SYNTAX SEQUENCE OF IfaceDescriptor
    ACCESS not-accessible
    STATUS mandatory
    DESCRIPTION
        “A list of the local interface cards, indexed by slot position.
      The table is fixed at 16 rows. One for each slot in the chassis.”
  ::={ localInterfaceDescr 1 }
ifaceDescription OBJECT-TYPE
    SYNTAX IfaceDescriptor
    ACCESS not-accessible
    STATUS mandatory
    DESCRIPTION
        “The addressing information for a particular interface card.
      The index is based on slot number within the chassis.”
    INDEX{ localSlotIndex }
    ::={ cLIGHTLocalInterfaceTable 1 }
IfaceDescriptor ::= SEQUENCE{
    localSlotIndex INTEGER,
    interfaceType INTEGER,
    ifaceFiberPortState INTEGER,
    ifaceUserPortState INTEGER,
    ifaceLANdata INTEGER,
    ifaceVersion DisplayString,
    ifacePSUStatus INTEGER,
    ifaceTemperature INTEGER,
    ifaceSerialNumber DisplayString,
    ifaceLanSpeed INTEGER,
    ifaceUserPortState INTEGER,
    ifaceFiberPortBState INTEGER,
    ifaceSystemConnectorType INTEGER,
    ifaceSystemFibreType INTEGER,
    ifaceSystemLaserType INTEGER,
    ifaceSystemLaserRange INTEGER,
    ifaceSystemWavelength DisplayString,
    ifaceUserPortConnectorType INTEGER,
    ifaceUserPortFibreType INTEGER,
    ifaceUserPortLaserType INTEGER,
    ifaceUserPortLaserRange INTEGER,
    ifaceUserPortWavelength DisplayString,
    ifaceUserPortConnectorType INTEGER,
    ifaceUserPortFibreType INTEGER,
    ifaceUserPortLaserType INTEGER,
    ifaceUserPortLaserRange INTEGER,
    ifaceUserPort2Wavelength DisplayString
    }
ifaceFiberPortState OBJECT-TYPE
```

| | |
|---|---|
| SYNTAX | INTEGER { inserted(1), checkRx(2), remoteFault(3) } |
| ACCESS | read-only |

```
        STATUS mandatory
    DESCRIPTION
```

“The state of the fiber port, values are inserted, device
correctly attached, wrapped, device incorrectly attached
and data is looped back within the port,or remoteFault
the port is wrapped but the far end device has been
recognized on the receive fiber.”

::= { ifaceDescription 3 }
ifaceFiberPortBState OBJECT-TYPE

| | |
|---|---|
| SYNTAX | INTEGER { inserted(1), checkRx(2), remoteFault(3) } |
| ACCESS | read-only |

```
        STATUS mandatory
  DESCRIPTION
```

“The state of the secondary fiber port, values are
inserted, device correctly attached, wrapped, device
incorrectly attached and data is looped back within the
port,or remoteFault the port is wrapped but the far end
device has been recognized on the receive fiber.”

::= { ifaceDescription 12 }
END

from this SNMP specification predictive facts are generated in an MIB compiler in which the mapping of the symbolic names of the management information to their Object Identifier and vice versa is stored. A typical output of the MIB compiler is shown below which is entered in the language of a PROLOG script and can be used as input for a PROLOG interpreter PI:

mibNode(iso, [1],valueAssignment,...).
mibNode(org, [1,3],valueAssignment,...).
mibNode(dod, [1,3,6],valueAssignment,...).
mibNode(internet, [1,3,6,1],valueAssignment,...).
mibNode(private, [1,3,6,1,4],valueAssignment,...).
mibNode(enterprises, [1,3,6,1,4,1],valueAssignment,...).
mibNode(XXXX, [1,3,6,1,4,1,9999],valueAssignment,...).
mibNode(cityLight, [1,3,6,1,4,1,9999,2],valueAssignment,...).
mibNode(localInterfaceDescr, [1,3,6,1,4,1,9999,2,2],valueAssignment,...).
mibNode(cLIGHTLocalInterfaceTable,
[1,3,6,1,4,1,9999,2,2,1],objectType,...).
mibNode(ifaceDescription, [1,3,6,1,4,1,9999,2,2,1,1],objectType,...).
mibNode(ifaceFiberPortState, [1,3,6,1,4,1,9999,2,2,1,1,3],objectType,...).
mibNode(ifaceFiberPortBState,
[1,3,6,1,4,1,9999,2,2,1,1,12],objectType,...).

Furthermore a program written in a predicative programming language PP is needed for access with which rules are defined as to how the individual management information can be found in the MIB of the NE. Below is a typical extract of a script PS written in PROLOG for the management information ifaceFiberPortState and ifaceFiberPortBState with a special embedded rule “varBind( . . . )” to access the management information of the SNMP MIB. In addition a rule “necModule( . . . )” is shown in which further embedded rules such as “is” are used for example.

```
%%%%%%%%%%%%%%%%%%%%%%%%%%%%%%%%%%%%
%% Typical Prolog script for the two specific alarms.
%%%%%%%%%%%%%%%%%%%%%%%%%%%%%%%%%%%%
%% Probable cause mappings (AlarmId, ProbableCause)
%% Auxiliary rules which map a value read from the MIB to an
%% enumerator used in the OS.
mapLocalFiberAlarmId(2, probablecauseRxFail).
mapLocalFiberAlarmId(3, probablecauseRemote).
%%%%%%%%%%%%%%%%%%%%%%%%%%%%%%%%%%%%
%% PROLOG Program with the following concept:
%%
%% Rule header: When the body is true the variables in the header
%% are filled with the calculated values, in this case the variables
Index
%% and ProbableCause. All further parameters are constants.
%%
%% Rule body: Here the conditions for an alarm are defined.
%% If a varBind (AlarmId) is found in the MIB of the device under the
%% Object Identifier [ifaceFiberPortState, Index] and this
%% has a value which represents an alarm (2 or 3) then this
%% rule is true overall.
%%
%% Alarm No.1: Local Fiber Port
necAlarm
    ( objectclassNe
    , objecttypeLocalFiberPort
    , −1
    , −1
    , 1
    , Index
    , ProbableCause
    , alarmseverityDefault
    , trafficdirectionIncoming
    , faultconditionNeutral
    ) :-
    varBind ([ifaceFiberPortState, Index], AlarmId),
    mapLocalFiberAlarmId(AlarmId, ProbableCause).
%% Alarm No.2: Local Fiber Port B
necAlarm
    ( objectclassNe
    , objecttypeLocalFiberPort
    , −1
    , −1
    , 2
    , Index
    , ProbableCause
    , alarmseverityDefault
    , trafficdirectionIncoming
    , faultconditionNeutral
    ) :-
    varBind([ifaceFiberPortBState, Index], AlarmId),
    mapLocalFiberAlarmId(AlarmId, ProbableCause).
%% rules for Mapping of modules with Embedded Rules “is”, “+” and
“*”
mapSSU2000Module(“Output E1”,  objecttypeOutputModuleE1, 1).
mapSSU2000Module(“Output DS1”, objecttypeOutputModuleDS1, 2).
necModule
    ( ModuleId
    , ObjectType
    , Subrack
    , Slot
    , −1
    , −1
    , opstateEnabled
    ) :-
    varBind([inName, Subrack, Slot], Name),
    mapSSU2000Module(Name, ObjectType, Id),
    ModuleId is Slot + 65536 * Id.
```

With the aid of this PROLOG script PS as well as the facts of the MIB Compiler the OS access through the TF function can now be implemented. One option for implementing this access consists of querying all management information from the NE (see FIG. 1, messages 1:get(MIB) and 2:response(MIB)) and making it available to the PROLOG interpreter as facts. The access to the management information can then be undertaken from any given PROLOG interpreter (e.g. the GNU Interpreter) by a backtracking method via all facts and rules.

To optimize the system performance the management information is stored in the function TF not as facts but in special data store optimized for fast access (see FIG. 1, 3:store(MIB)). This data store is preferably in programmed in an imperative language such as C++.

There follows a typical extract from the Runtime System RS as well as from the PROLOG Interpreter PI of the function TF which lists how in this exemplary embodiment a query 4:get(Alarms) of the function OSF to the function TF via step 5:onGetAlarms( . . . ) V 6:processQuery( . . . ) V 7:Solve( . . . ) V 8:SolutionFound( . . . ) V 9:AlarmSolution( . . . ) leads to a response 10:response(Alarms) of the function TF to the function OSF:

```
/************************************************************************
Example for calling the PROLOG Interpreter to resolve a PROLOG rule from
C++. The method OnGetAlarms is called at the request of the OS. In this
exemplary embodiment the MD has at this point already retrieved all
varBinds (= Management Information of the SNMP MIB of the NE) for calculation
of the alarms from the NE.
************************************************************************/
/*05:*/
void CGenericSnmpFaultManager::OnGetAlarms
    ( CAlarmRecordMap& arrayAlarmRecordMap )
{
    /* Initially a pointer to the data store from which the varBinds
    can be read out is stored in the variable pMib.
    */
    CMibTree* pMib = GetMib( );
    /* Then the interpreter is called to which a PROLOG query is transferred
    as a string. The variables of the query are then filled with
    values when an alarm is found. These can also be a number of
    alarms. So that the Prolog interpreter can transfer a found solution
    back to a C++ function again, this is transferred as a parameter
    as well (AlarmSolution is a function pointer).
    */
    m_pInterpreter->ProcessQuery
    ( pMib
    , “necAlarm
      ( Class, ObjectType, Shelf, Slot, Container, Object
      , ProbableCause, Severity, Direction, Condition).”
    , &arrayAlarmRecordMap
    , AlarmSolution);
}
/************************************************************************
Example of an implementation of the method ProcessQuery(...)
************************************************************************/
/*06:*/
bool CInterpreter::ProcessQuery
```

| | |
|---|---|
| ( CMibTree* | pMib |
| , const CString& | strQuery |
| , void* | pClient |
| , LPQUERYSOLVEDCALLBACK | lpCallback |
| ) | |
| { | |

| | |
|---|---|
| m_pQueryTerms | = m_pParser->ParseQuery(strQuery); |
| m_nSolutionsFound | = 0; |
| m_pLocalStack | = m_aStack.GetData( ); |

```
    Solve
    ( m_pQueryTerms
    , m_pLocalStack
    , pClient
    , lpCallback
    );
    return m_nSolutionsFound != 0;
}
/************************************************************************
Example of an implementation of the method Solve(...)
The Solve method is essentially the heart of the PROLOG interpreter. This
means that it is in a position to execute the rules defined in the PROLOG
script PP. The else if branches establish whether built-in predicates are
involved. One of these is the varBind predicate to allow access to the
SNMP MIB from Prolog.
************************************************************************/
/*07:*/
void CInterpreter::Solve
```

| | |
|---|---|
| ( CTerm* | pGoals |
| , SInvocationStack* | pParentFrame |
| , void* | pClient |
| , LPQUERYSOLVEDCALLBACK | lpCallback |

```
    )
{
    IF (pGoals != NULL)
    {
        CTermList* pTermList = NULL;
        pTermList = pGoals->m_pRules;
        IF (pTermList != NULL)
        {
            ...
        }
        // Embedded PROLOG construct “varBind(...)”
        else if (pGoals->GetTermValue( ) == “varBind”)
        {
```

| | | |
|---|---|---|
| CMibTree* | pTree | = GetMib( ); |
| CTerm* | pOidList | = pGoals->m_aArgumentTerms[0]; |
| CTerm* | pMibVar | = pGoals->m_aArgumentTerms[1]; |

```
            if (pTree != NULL)
            {
                // SolveVarBind handles the access to the MIB
                // without violating prolog semantic
                SolveVarBind
                    ( pTree
                    , pOidList
                    , pMibVar
                    , pGoals->GetNextTerm( )
                    , pParentFrame
                    , pClient
                    , lpCallback
                    );
            }
        }
        // Embedded PROLOG construct “... is ...”
        else if (pGoals->GetTermValue( ) == “is”)
        {
            ...
        }
        // other Embedded PROLOG constructs
        else if (...)
        {
            ...
        }
        else if (...)
        {
            ...
        }
    }
    else
    {
        // No more resolvents -> Solution found
        m_nSolutionsFound++;
        SolutionFound(pClient,lpCallback);
    }
}
/************************************************************************
Example of an implementation of the method SolveVarBind(...)
The SolveVarBind implements varBind calls such as:
    “varBind([ifaceFiberPortState, Index], AlarmId)”
In this case there are accesses to the MIB which are initially transferred
as parameters as well. The pointer to the MIB is simultaneously a
pointer to the root node. In abstract terms this function makes sure that
the SNMP stored data appears as PROLOG facts but without having to be
present in the stored PROLOG data for this purpose. Data and rules in
PROLOG are encapsulated by CTerm.
************************************************************************/
void CInterpreter::SolveVarBind
```

| | |
|---|---|
| ( CMibNode* | pCurrentNode |
| , CTerm* | pOidList |
| , CTerm* | pVar |
| , CTerm* | pResolvents |
| , SInvocationStack* | pParentFrame |
| , void* | pClient |
| , LPQUERYSOLVEDCALLBACK | lpCallback) |
| { | |
| CTerm* | pOidNode = pOidList->m_aArgumentTerms[0]; |
| int | nNodeId = pOidNode->GetIntValue( ); |

```
    ...
    pCurrentNode = pCurrentNode->FindChildById(nNodeId);
    IF ( pCurrentNode != NULL
      && pCurrentNode->IsKindOf(RUNTIME_CLASS(CScalarNode))
      )
    {
        // We have reached a leaf
        CTerm varBind;
        // The leaf represents the value of the varBind
        CAsnIntegerValue* pIntVal = pCurrentNode->GetValue( );
        // and is edited as a Prolog Term
        VarBind.SetDiscriminator(ETD_Integer);
        VarBind.m_nValue = pIntVal->m_Val;
    }
    ...
}
/************************************************************************
Example of an implementation of the method SolutionFound(...)
************************************************************************/
/*08:*/
void CInterpreter::SolutionFound
```

| | |
|---|---|
| ( void* | pClient |
| , LPQUERYSOLVEDCALLBACK | lpCallback |
| ) | |
| { | |
| // (*lpCallback) | points to the method AlarmSolution(...) |

```
    // m_sQuery.m_pStackFrame points to the stack of the interpreter
    (*lpCallback)
        ( pClient
        , m_sQuery.m_pStackFrame
);
}
/************************************************************************
Example of an implementation of the method AlarmSolution(...)
With this method, when a solution is found to the PROLOG query transferred
in OnGetAlarms(...) there is a branch back from the PROLOG interpreter
to C++. It shows how a result determined by the Prolog Interpreter
is accessed from C++. In this case
```

| | |
|---|---|
| => | pSolution is pointer to the runtime stack of the interpreters. The |
| | desired variables Class, ObjectType, ..., Condition lie in the sequence |
| | on the stack in which they were transferred for ProcessQuery |
| | in the PROLOG query. |
| => | NecAlarm_t is the OS representation of an alarm. This is filled and |
| | stored in a hash table. |
| => | GetAssociatedMeaning( ) is an encapsulation of the actual access to |
| | the computed values. |

At the end the result is sent in response(...) to the OS.
************************************************************************/
/*09:*/
void CGenericSnmpFaultManager::AlarmSolution

| | |
|---|---|
| ( void* | pArray |
| , CTerm** | pSolution |
| ) | |
| { | |
| CAlarmRecordMap* | pAlarmRecords = (CAlarmRecordMap*) pArray; |
| NecAlarm_t | sAlarm; |

```
    // Get PROLOG query results from interpreter stack
    sAlarm.AffectedObjectId_s.NeId_dw = 0;
    sAlarm.AffectedObjectId_s.ObjectClass_e =
```

| | |
|---|---|
| ObjectClass_t | (pSolution[0]->GetAssociatedMeaning( )); |

sAlarm.ObjectRef_s.ObjectType_e =

| | |
|---|---|
| ObjectType_t | (pSolution[1]->GetAssociatedMeaning( )); |

sAlarm.ObjectRef_s.ShelfNumber_w =

| | |
|---|---|
| WORD | (pSolution[2]->GetIntValue( )); |

sAlarm.ObjectRef_s.SlotNumber_w =

| | |
|---|---|
| WORD | (pSolution[3]->GetIntValue( )); |

sAlarm.ObjectRef_s.ContainerIndex_dw =

| | |
|---|---|
| DWORD | (pSolution[4]->GetIntValue( )); |

sAlarm.ObjectRef_s.ObjectIndex_dw =

| | |
|---|---|
| DWORD | (pSolution[5]->GetIntValue( )); |

sAlarm.ProbableCause_e =

| | |
|---|---|
| ProbableCause_t | (pSolution[6]->GetAssociatedMeaning( )); |

sAlarm.Severity_e =

| | |
|---|---|
| AlarmSeverity_t | (pSolution[7]->GetAssociatedMeaning( )); |

sAlarm.TrafficDirection_e =

| | |
|---|---|
| TrafficDirection_t | (pSolution[8]->GetAssociatedMeaning( )); |

sAlarm.FaultCondition_e =

| | |
|---|---|
| FaultConditions_t | (pSolution[9]->GetAssociatedMeaning( )); |

pAlarmRecords->response(sAlarm, 0);
}

The accessed Management Information ifaceFiberPortBState is sent to the function OSF using the method response( . . . ). Thus the transformation of the SNMP MIB for this access is completed.

In conclusion it should be pointed out that the description of the components of the TMN system relevant for the invention should not basically be understood as imposing any restrictions in respect of a specific physical implementation or assignment. For an appropriate person skilled in the art it is especially evident that all functional units can be implemented in part or as a whole in software/computer program products and/or distributed over a number of physical devices.

1-10. (canceled)

11. A Transformation Function of a TMN system, wherein the Transformation Function is implemented with the aid of at least one program programmed in a predicative programming language.

12. The Transformation Function according to claim 11, wherein the Transformation Function includes the program.

13. An interpreter for a predicative programming language, comprising at least one build-in predicate, wherein the processing of the predicate includes a method implemented in an imperative programming language which executes access to management information of a management information base of a network element such that the management information appears for the interpreter as facts of a predicative programming language.

14. A predicatively programmed program, wherein the program is usable for transforming management information of a management information base of a network element of a TMN system such that the management information can be processed by an Operations System of the TMN system.

15. A program programmed in a predicative programming language for implementing a Transformation Function of a TMN system.

16. The program according to claim 15, wherein the program is stored on a computer readable medium.

17. The program according to claim 15, wherein the computer readable medium is a floppy disk, CD, DVD, memory card or USB-Stick.

18. A method for executing a Transformation Function of a TMN system, comprising the following steps:
analyzing a management information base by a program programmed in a predicative programming language; and
transforming results of the analysis by a program programmed in any given programming language.

19. The method in accordance with claim 18, wherein the transforming step is performed by an imperatively programmed program.

20. The method in accordance with claim 18, wherein the management information base is loaded from a network element before the analyzing step.

21. The method in accordance with claim 19, wherein the management information base is loaded from a network element before the analyzing step.

22. A device comprising mechanisms for performing a method for executing a Transformation Function of a TMN system, the method comprising:
analyzing a management information base by a program programmed in a predicative programming language; and
transforming results of the analysis by a program programmed in any given programming language.

23. The device in accordance with claim 22, wherein the device is a Mediation Device or an Adaption Device.

24. The device in accordance with claim 22, further comprising:
an interpreter for a predicative programming language, comprising at least one build-in predicate, wherein the processing of the predicate includes a method implemented in an imperative programming language which executes access to management information of a management information base of a network element such that the management information appears for the interpreter as facts of a predicative programming language, and wherein
the Transformation Function is implemented with the aid of at least one program programmed in a predicative programming language.

25. A TMN system, comprising:
at least one Transformation Function implemented with the aid of at least one program programmed in a predicative programming language; and/or
at least one interpreter for a predicative programming language, comprising at least one build-in predicate, wherein the processing of the predicate includes a method implemented in an imperative programming language which executes access to management information of a management information base of a network element such that the management information appears for the interpreter as facts of a predicative programming language; and/or
at least one predicatively programmed program, wherein the program is used to transform management information of a management information base of a network element of a TMN system such that the management information can be processed by an Operations System of the TMN system; and/or
at least one device comprising mechanisms for performing a method for executing a Transformation Function of a TMN system, the method comprising:
analyzing a management information base by a program programmed in a predicative programming language; and
transforming results of the analysis by a program programmed in any given programming language.
